(19) United States
(12) Patent Application Publication
(10) Pub. No.: US 2012/0225725 A1
(43) Pub. Date: Sep. 6, 2012

(54) PACASPACEDEBRIS Environmental Gaming Protocol

(76) Inventors: Ana Maria Velasco-Tang, Lake Elsinore, CA (US); Philip Arun Venturelli, Lake Elsinore, CA (US); Christopher Peter Tang, Yorba Linda, CA (US); Alexander Peter Tang, Yorba Linda, CA (US)

(21) Appl. No.: 13/410,265

(22) Filed: Mar. 1, 2012

Related U.S. Application Data
(60) Provisional application No. 61/447,798, filed on Mar. 1, 2011.

(51) Int. Cl. A63F 9/24; B01J 19/12; G01C 21/00

(52) U.S. Cl. 463/42; 250/203.1; 250/492.1

(57) ABSTRACT

One embodiment of a machine for the detection, tracking, and removal of 1-10 cm sized space debris is described. This machine utilizes a communications channel comprising both software and hardware in order to make use of information from the players of an augmented reality computer game, so as to combine this information with other information from a global network of tracking optical space debris sensors. This approach to solving the problem of 1-10 cm space debris has a number of advantages over prior art. Other embodiments are described and shown.

### CROSS-REFERENCE TO RELATED APPLICATIONS

This application claims the benefit of provisional patent application Ser. No. 61/447,798 filed 2011 Mar. 3 by Ana Maria Tang, the first named inventor of the present patent application.

### BACKGROUND

### Prior Art

The following is a tabulation of some prior art that presently appears relevant:

### Non-Patent Literature

Bekey, I. “Orion's Laser: Hunting Space Debris.” Space Future. May, 1997.

Kessler, D. and Cour-Palais, B. Collision frequency of artificial satellites: The creation of a debris belt. J. of Geophys. Res., 83(A6), 2637-2646, 1978.

Liou, J.-C. and Johnson, N. Instability of the present LEO satellite populations. Adv. Space Res., 41, 1046-1053, 2008.

Liou, J.-C. An Active Debris Removal Parametric Study for LEO Environment Remediation. Adv. Space Res., Vol 47, Issue 11, p. 1865-1876, 2011.

Mason, J., Stupl, J., Marshall, W., Levit, C. Orbital Debris-Debris Collision Avoidance. arXiv:1103.1690v3 [physics.space-ph]

Shell, J. R. Optimizing Orbital Debris Monitoring with Optical Telescopes, AMOS Conf. 2010

The skies are home to thousands of satellites and spacecraft which (a) provide vital scientific data on the health of our planet, (b) establish communications for the global shipping network which keeps the world's economies humming, (c) provide global telecommunications in the form of satellite telephones, television, radio, and internet, and (d) protect our nations from the threat of invasion and nuclear attack by providing missile launch warning capabilities. The importance of satellites for the benefit of humanity cannot be underestimated.

Space debris are now clouding our near-Earth environment and are colliding with both functional satellites and other debris objects thus creating an ever-increasing population of debris. The Low-Earth Orbit environment has now become overcrowded with debris from past missions, satellite collisions, and accidental or intentional explosions. See the drawing entitled “resident space object” for an understanding of the present situation. For example, Sun Synchronous Orbit which is crucial for Earth-Imaging satellites has already exhibited indications of having become overcrowded by debris. [Liou and Johnson 2008] When this occurs, debris objects cluster together in an orbit creating belts, which then become dense enough that a run-away chain of collisions will begin (a “collisional cascade” where debris collisions create more debris which in turn causes more collisions) thereby destroying all satellites and spacecraft in that orbit and rendering an the entire orbit unusable. This effect is described by NASA scientist Donald Kessler as the Kessler Syndome in [Kessler 1978] Consequently, experts at NASA [Liou 2011] recognize the present danger posed by space debris for the satellites and spacecraft which serve humanity. It is their expert testimony that the debris fragments between 1 and 10 centimeters in size present “the greatest threat to spacecraft today” since they are small enough that there is no network capable of tracking them from the ground, thus their positions and orbits are largely unknown. In other words, orbital positions of the 1-10 cm sized debris are not maintained in a catalog due to inadequate sensor coverage. Furthermore, debris of this size are large enough to damage virtually any satellite/spacecraft with which they collide. Moreover there are over 500,000 of these debris objects in orbit around the Earth, a number which is increasing rapidly (between 2007 and 2009 the number of debris objects doubled as a result of two collision events which created over 250,000 new debris objects greater than 1 cm in size) [Shell 2010]. Therefore the probability of collision between satellites/spacecraft and orbital debris is projected to increase without bound over time [Liou and Johnson 2008].

Multiple endeavors have been made to address this humanitarian threat which has the potential to result in a world-wide economic and environmental catastrophe (should the Kessler Syndrome set in throughout Low Earth Orbit, thus destroying satellites and blocking humanity's access to space). Some of these endeavors, such as NASA's Orion Project [Bekey 1997] advocated the use of lasers to eliminate debris by propelling debris objects into the Earth's atmosphere. The Collision Avoidance plan of Mason [Mason 2011] proposes to use weaker laser beams to deflect debris objects in the event of a collision. Still others (DARPA, EOS, Shell, Oceanit) propose to increase space situational awareness by creating a catalog of space debris with refined estimates of orbital positions and velocities. Still others propose to remove debris “manually” by launching debris collector satellites, nets, Aerogel, bombs, or other devices.

The shortcomings of each of these approaches are as follows. Project Orion requires the fielding of at least one powerful military-grade laser, which infringes upon international treaties on arms and the peaceful uses of outer space. Furthermore, the cost of such a laser is so great that the benefit has not yet been seen to outweigh the initial investment. The plan of Mason fails to provide an actual solution for the removal of debris from space (it only proposes to help prevent collisions on a case by case basis). DARPA has engineered a multi-million dollar telescope which is designed to detect debris in Geosynchronous orbit, and has not addressed the threat near the Earth in Low Earth Orbit. EOS has designed a facility for space debris observation, however their effort requires many facilities throughout the world in order to efficiently catalog the full space debris population in Low Earth Orbit, and such facilities as designed are expensive to build and operate. Shell describes an inexpensive device for the observation of space debris, however his design as stated is unable to achieve the long durations of geometric access time to clouds of debris objects required to rapidly catalog them. Oceanit describes a network for space situational awareness but not for meeting the sensitivity requirements of 1-10 cm debris objects in Low Earth Orbit. Furthermore, DARPA, Oceanit, Shell and EOS have not provided solutions for the actual removal of debris; they merely propose to augment current observational and tracking capabilities. Finally, others who propose the launch of debris collector systems into space risk contributing to the existing debris problem should their debris collector fail to operate as planned. As can be seen, while each prior approach offers certain advantages, each approach also introduces new complications and short-comings There is therefore a need in the art for a solution to the space debris problem which overcomes these limitations.

### Advantages

One embodiment functions to prevent an environmental disaster from occurring.

One embodiment has the advantage of combining tracking functionality with an optical telescope, enabling the use of the resulting high performance optical sensor for cuing a Laser Debris Removal Station for active debris removal.

In one embodiment, the tracking optical sensor has superior performance over prior art as shown in computer simulations for geometric access.

One embodiment enables a novel method for solving difficult problems such as the optimal placement of observatories on the Earth and the optimal removal strategy for 1-10 cm space debris objects given a dynamic space debris catalog.

One embodiment advances education and communication with inhabitants of remote communities regarding the space debris problem on a global scale.

### GLOSSARY

### Terms in Claim 1:

resident space objects satellites and space debris, see the drawing entitled “resident space objects” for a depiction of the resident space object population

optical telescope a housing together with optical elements (see definition under Terms in Claim 3) which function to gather and focus light

predetermined aperture diameter see the drawing entitled “motorized pivoted support”, the embodiment of the ARO described in the specification requires an aperture diameter greater than 10 cm

motorized pivoted support a motorized mechanical structure coupled to the optical telescope, see the drawing entitled “motorized pivoted support”

focal plane arrays image sensing devices consisting of arrays of light-sensing pixels at the focal planes of an optical sensor, see the drawing entitled “optical sensor”

fields of view of predetermined angular dimension an angular measure of at least 3 degrees for the embodiment of the ARO described in the specification

computer system see the drawings entitled “optical sensor” and “computer system”

electrical signal see the drawing entitled “optical sensor”

control signal see the drawing entitled “optical sensor”

telescope to follow to maintain geometric access (or line of sight) between said telescope and the target resident space objects, such a process may require a feedback control system such as the system depicted in the drawing entitled “telescope to follow”

first radio frequency communications device see the drawing entitled “first radio frequency communications device” for one embodiment of such a device

control station a plurality of computer systems processing data from a plurality of AROs and game players

second radio frequency communications device see the drawing entitled “second radio frequency communications device” for one embodiment of such a device

mobile devices handheld computers (e.g. mobile telephones), laptops, or tablet devices

villagers people in small towns who have virtually no means of communication

### Terms in Claim 2:

communications channel see the drawing entitled “communications channel” for one embodiment of a communications channel, a second embodiment of a communications channel comprises said drawing where the mentor's computer is a mobile device

players see the drawing entitled “communications channel” for two embodiments of “players”

local networks see the drawing entitled “communications channel” for one embodiment of a local network

positive information exchange an exchange comprising teaching regarding a solution to the space debris problem as said problem arises in either the game world or the real world

mentor one or more people who engage in the act of teaching one or more players regarding a solution to the space debris problem as said problem arises in either the game world or the real world

mentee one or more players who engage in the act of learning from one or more mentors regarding a solution to the space debris problem as said problems arises in either the game world or the real world

mentorship opportunities the possibility to engage in a positive information exchange

space debris theme the unifying or dominant subject of space debris or more generally resident space objects

scientifically systematically or accurately

reduce to treat analytically

central router means an RF communications device which is part of an ARO, see the drawing entitled “communications channel” for one embodiment of a central router means

computing device see the drawing entitled “communications channel” for two embodiments of computing devices

codes creative approaches undertaken by the player as he or she solves problems within the game

space debris problem the fact that Earth's orbital environment has become populated with resident space objects to an extent where collisions between objects are possible

social media websites web sites and other online means of communication that are used by large groups of people to share information and to develop social and professional contacts

upstream network see the drawing entitled “communications channel” for one embodiment of an upstream network

Terms in Claim 3:

laser beam generators see the drawing entitled “laser beam generator” for one embodiment of a laser beam generator

perturb the orbits of resident space objects in a predetermined manner to modify the orbit of one or more resident space objects with the ultimate goal of removing said resident space objects from orbit. See drawing entitled “perturb the orbits of resident space objects example” for an example of how many incremental perturbations can lead over time to the removal of resident space objects from orbit.

beam director see the drawing entitled “beam director” for one embodiment of a beam director

optical elements components used to transmit, reflect, or otherwise manipulate light

beam correction systems see the drawing entitled “beam correction system components example” for embodiments of components of beam correction systems

beam pointing systems see the figure entitled “beam pointing system example” for one embodiment of a beam pointing system

laser beam generator for illuminating resident space objects a laser beam generator capable of generating a laser beam of less power than that required to perturb the object of said resident space object

increase the accuracy to a predetermined level of said beam steering system increase the accuracy of said beam steering system to a level where the laser beam from said beam steering system is incident upon said resident space objects

tracking lock see the drawing entitled “tracking lock” for the output of one embodiment of a system establishing a tracking lock

predetermined portion of resident space objects' overhead passes the full range of elevation angles subject to visibility constraints, or from elevation angles corresponding to initial visibility through to zenith on an ascending pass, or from zenith through to an elevation corresponding to final visibility on a descending pass

### Terms in Claim 7:

deformable mirror see the drawings entitled “laser guide star and adaptive optics means example” and “adaptive optics means example” for embodiments of a deformable mirror (also referred to as DM in the drawings)

wavefront sensor see the drawings entitled “laser guide star and adaptive optics means example” and “adaptive optics means example” for embodiments of a wavefront sensor (also referred to as WFS in the drawings)

computer systems a computer means performing in one embodiment the functions of image post processing and actuator control, shown in the drawing entitled “laser guide star and adaptive optics means example”. In a second embodiment the computer system comprises an adaptive optics means such as shown in the drawing entitled “adaptive optics means example”

atmospheric effects The atmosphere has two major effects on the laser beam: scintillation, which causes incoherence and spreading of the beam, and nonlinear effects, which spread the beam in wavelength, spatially, or both. The chief nonlinear effects analyzed were turbulence, absorption, dirty air breakdown, stimulated Raman scattering, whole-beam thermal blooming, stimulated thermal Rayleigh scattering, and nonlinear refractive index.

### Terms in Claim 8:

secondary laser beam generators see the drawing entitled “second laser beam generator” for one embodiment of a secondary laser beam generator

beam control system see the drawing entitled “beam control system” for one embodiment of a beam control system

portion of the upper atmosphere the part of the upper atmosphere utilized by either a sodium or a Rayleigh beacon guide star

### Terms in Claim 9:

model of the effect of photon pressure calculations involving the effect whereby a laser beam produces a force on one or more debris objects due to energy and momentum exchange with photons in said laser beam

### Terms in Claim 10:

model of the Poynting-Robertson effect calculations involving the effect whereby a laser beam produces a force on one or more debris objects due to Poynting-Robertson drag. Poynting-Robertson drag arises from absorption and anisotropic re-emission of photons by one or more debris objects as seen in the Earth's reference frame. In the reference frame of the debris, re-emission is isotropic, however due to the debris' velocity, radiation from the Earth comes from a slightly forward direction (instead of perpendicular to the velocity vector, as would typically be the case for a circular orbit). Thus absorption of photons imparts angular momentum. In the Earth's reference frame, reemission is anisotropic and a decrease in angular momentum is the result of a drag force which is proportional to the debris' velocity.

### Terms in Claim 11:

model of the effect of ablation calculations involving the effect whereby a laser beam ablates a thin surface layer of one or more debris objects and causes plasma blowoff

### Terms in Claim 12:

information gateway a software structure or hardware element which modifies or regulates the flow of information

### Terms in Claim 13:

space debris gaming software elements software comprising the space debris game tied either to one or more mobile devices or to a computer system upstream from the mobile devices

### Terms in Claim 15:

bi-directional information filter

a system that removes redundant or unwanted information from an information stream flowing in both directions using automated, semi-automated, or computerized methods

machine learning algorithms algorithms classified under artificial intelligence, machine learning is a scientific discipline concerned with the design and development of algorithms that allow computers to evolve behaviors based on empirical data, such as from sensor data or databases. Examples of such algorithms are artificial neural networks, genetic algorithms, and genetic/evolutionary algorithms used in conjunction with artificial neural networks. See the drawing entitled “machine learning algorithm” for more information on machine learning algorithms in the embodiment of a neural network.

### Terms in Claim 17:

synthetic aperture technology incorporates the data from optical sensors and the measurement uncertainties for the orientation of these sensors, along with point spread function models corresponding to the imaging capabilities of each sensor, see the drawing entitled “synthetic aperture”

### DETAILED DESCRIPTION AND OPERATION

### First Embodiment

In one embodiment, PACA Space Debris Environmental Gaming Protocol involves the development of both hardware and software which provide a cost-effective method for removing debris from low earth orbit. From the hardware perspective, the PACA Automated Remote Observatory (ARO) technology institutes a tracking optical sensor which can achieve long time durations of geometric access in a single pass of a debris cloud over the ARO. Compare the drawings entitled “fixed pointing optical performance analysis” and “tracking optical sensor performance analysis” which are the result of a computer simulation indicating the extent to which a tracking optical sensor for is superior to a fixed-pointing optical sensor. To minimize costs, this sensor is built with off-the-shelf hardware. By positioning multiple AROs around the globe, an advanced cost-effective Space Situational Awareness (SSA) network can be established which can detect, track, and catalog debris from 1 to 10 cm in Low Earth Orbit.

While such a catalog could be used to determine which satellites are at risk from collisions and to provide a warning to satellite operators to execute an emergency satellite maneuver to dodge debris, the aforementioned embodiment aims to address the full scope of the space debris problem by providing a means for manipulating/removing space debris between 1 and 10 cm in size. Debris removal is achieved via the PACA Laser Debris Removal Stations (LDRS) which institute a cost-effective method for the removal of space debris using non-military grade high power solid state laser technology. LDRS can be placed at predetermined locations around the globe to create a network capable of targeting and eliminating 1-10 cm space debris. More information on the PACA ARO, PACA LDRS, and other subsystems of the aforementioned embodiment will be provided below.

A further advance offered by this embodiment is the solution to the problem of 1 to 10 cm space debris by utilizing both hardware and software to establish a network for observation, computing, and laser debris removal that integrates “gaming” on mobile devices. In this context, gaming signifies the actual process of enabling players to develop solutions to the problems of detecting, tracking, cataloging, and removing space debris from Earth orbit. Therefore players play an active and functional role in the resolution of the space debris problem through the virtual environment provided by the game.

The present embodiment of the PACA Space Debris Environmental Gaming Protocol will be used by people, mostly by young people, in the form of a game. This game is designed to provide a real-time simulation of space debris dynamics and to provide the player with the ability to observe, catalog, and selectively remove debris from Earth's orbit using a variety of approaches. One example of such an approach is the use of a laser beam originating from one or more sites on the Earth. The game is designed to incorporate as much actual physics in a fun way as possible without making game play and user interaction overly burdensome.

The aforementioned game will enable players to view a three-dimensional representation of the virtual space debris as it orbits the Earth, and to change perspectives to show views from virtual observatories on the Earth. The player will first try to establish a debris catalog complete enough to enable debris removal. This is done by coordinating with other virtual observatories to scan the skies for 1 cm to 10 cm sized space debris. Once such debris has been detected, astrometry (use of angles to calculate the orbital state vectors) may be used to determine the ephemerides of the debris objects. By displaying predicted trajectories and orbital covariances (error ellipsoids) for debris objects, the game will allow the player to improve the accuracy of the orbital elements composing debris ephemerides. Once the accuracy has reached a predetermined threshold (established by the pointing capabilities of the lasers) the game allows the building of virtual Laser Debris Removal Stations. The player can use these systems to selectively target debris in critical orbits which need “rescuing” and use the laser beam to modify the orbit of the debris objects until they are eventually removed. The game will advance in levels so that every time the player catalogs, removes a debris object, or becomes part of a pairing between a mentor and a villager (see the drawing entitled “communications channel”) he is awarded points. Points may be used, for example, to build virtual observatories or to field virtual LDRS, and when a certain number of points are accumulated the game level advances. At this point, the detail, realism, and difficulty of the game increases. When the score/level advances, statuses are posted to any accounts/social media subscriptions that the user has registered such as Facebook, etc. For the purposes of the following discussion, the use of the word ‘virtual’ to denote objects within the game will be suspended as it may prove cumbersome to the reader. It is therefore understood that the ARO and the LDRS are virtual when discussed in the context of the game, and real/physical when discussed outside that context or explicitly referred to as “real”.

As can be gathered from the above discussion, the gameplay is engineered to be similar in essence to what actually takes place within a real observatory or network of real observatories as they work to detect and catalog space debris. Also, parts of the game approximate the steps that need to take place before such debris can be removed using a real laser debris removal system. To further establish a bridge between gameplay and reality, as the player plays the game, software running on the device the player is using to access the game will capture and process creative approaches undertaken by the player as he or she solves problems within the game. These creative approaches are hereafter referred to as “codes.” These codes will be transmitted to a computer network which will be in communication with a real observatory. This observatory will actually engage in the act of detection/cataloging of debris, and may utilize some of the player's codes in configuring its pointing/tracking/control algorithms to image debris in space.

As real debris objects travel 400 msec or more around the Earth, the telescope will be tracking and computers will be measuring the ephemerides of the debris. Based on these measurements, calculations will be undertaken for the amount of time needed to remove the debris from orbit. Some portion of this information will be communicated back to the player of the game, increasing the realism, detail, and difficulty of gameplay. In this manner, the game successively approximates the reality of the space debris removal problem by utilizing data from real observatories positioned around the globe to cue the difficulty, realism, and detail of gameplay. The players in turn provide their own contribution from the codes that they generate which are increasingly applicable to the real space debris removal scenarios. One example of such an application is to determine via the codes of multiple players an optimal sequence for removing debris from a particular orbit which may take the form of “fire at any debris that enters the telescope field of view” or a more strategic plan. Such an optimal debris removal strategy has been the subject of many investigations [Mason 2011, Bekey 1997] and most have returned with the simplest “fire and forget” solution [Bekey 1997] however it is possible that a better approach exists, and it is an object of this embodiment to find one.

In the game, each player tries to complete his or her level, and tries to be ahead (e.g. to accumulate more points) of the other players while at the same time inserting codes (e.g. to resolve the debris ephemerides). The strategy for doing this may comprise focusing on cataloging the debris in key/crowded orbits, thereby placing observatories around the globe which provide the best possible geometric access to debris in those orbits. In fact, the optimal placement of observatories is another example of a problem which has not been fully solved in the real world by efforts to study the real space debris problem. For example, [Mason 2011] proposes the above approach—placing observatories and laser facilities so that they have the longest durations of geometric access to debris in chosen orbits (e.g. Sun Synchronous Orbit). However if one is to create a debris observation and removal network of ARO and LDRS around the world, what would be the best way to do so given what being learned about the space debris population? One approach would be to place ARO and/or LDRS at increments of latitude so as to establish a “grid” on the Earth. This way, as the Earth rotates any given point on the Celestial Sphere will receive coverage. However the space debris are not fixed points in an inertial coordinate system, but rather moving objects which orbit the Earth at velocities independent of the Earth's rotation. This suggests that there may be a better solution to this problem beyond the grid approach or the “find out the orbits of the debris and then decide where to put the ARO/LDRS” approach. It is an object of the aforementioned embodiment to find such a solution using the input of players from the game.

Meanwhile, in reality, at a Control Station, Engineers and Scientists collaborate in the effort to remove space debris. Orbital elements from the catalog and concurrent observations from remote observatories will be used to cue the Laser Debris Removal Stations which comprise a network of ground-based observatories outfitted with beam directors, high power solid state lasers, control electronics, and other technologies (e.g. adaptive optics). After coordinating with the US Laser Clearinghouse and other international organizations to verify laser firing safety (no accidental damage to commercial airliners or working satellites/spacecraft which happen to be passing by at the wrong time), the laser debris removal targeting system will take over and irradiate the target debris object. Updated orbital elements will be determined from concurrent observations from remote observatories and the debris will be irradiated again on subsequent orbital passes.

This will continue until the targeted debris has been removed or its orbit modified so as to ensure timely removal due to natural decay. During this process, a portion of the data generated will be used to enhance the realism, difficulty, and detail of the game thereby providing a bi-directional learning network (artificial intelligence system) which evolves both from the standpoint of the game and from the standpoint of reality where codes from the players help solve real problems faced by engineers and scientists. The critical element is therefore the communications gateway (information filters) which control the flow of detail and information between the PACA hardware systems (observatories, laser debris removal stations, and Control Station) and the software systems (game interface and the mentor/mentee interface which provides advice to the players which may influence their game play).

An example of such an information filter may take the form of a machine learning algorithm such as an artificial neural network, which is depicted in a basic configuration in the drawing entitled “machine learning algorithm.” Such a network may be designed/implemented in concurrence with a genetic algorithm for evolving the neural network with respect to the physical/virtual environment.

### The Automated Remote Observatory (ARO):

It is known in the art that classes of optical instruments recently pioneered by the astronomical community with an objective of characterizing transient events such as gamma ray bursts and extra solar system planetary transits have demonstrated the potential to provide high volume monitoring of orbital debris, enabled by large fields of view (greater than 3 degrees per aperture). These instruments, however, have typically long integration times which are not optimized for detecting high angular rate LEO debris, resulting in degraded detection performance. Optimizing the integration time of these optical sensors in combination with tracking or cued detection capabilities enables significant performance for orbital debris monitoring beyond the level of prior art.

The ARO enables the gathering of astronomical and astrometric data, storage of data processing of data, transmission of data via a satellite uplink, receipt of data via satellite downlink, and potential transmission/receipt of data via local WiFi/Mesh. The ARO is capable of tracking Resident Space Objects (RSO) larger than 1 cm in size, and it has the ability to relay data to a Control Station where said data may be processed and used to generate orbital catalogs. These orbital catalogs may then be used to calculate RSO trajectories and risks of collision with existing satellites in orbit around the Earth. Data and recommendations may then be sold to companies, satellite operators, and governments interested in monitoring the RSOs. Data and recommendations may also be provided to a debris removal system such as the Laser Debris Removal Stations (LDRS).

It is known in the art that few companies have data on RSOs less than 10 cm in size and there is a rapidly growing need for such data since, as reported by NASA, the Kessler Syndrome is likely to be already in effect in certain orbits and sets of orbits. [Mason 2011] The “Kessler Syndrome” involves a runaway growth of debris produced from cascading collisions, whereby the rate of debris creation through debris-debris collisions would exceed the ambient decay rate and would lead to the formation of debris belts. This syndrome predicts large growth in the number of space debris objects within an orbit or a set of orbits and an increase in the collision rate between debris objects and satellites/spacecraft. Due to the danger which space debris poses to satellites and spacecraft, it is of great importance to humanity that the debris population and more generally the RSO population of size greater than 1 cm be cataloged to the greatest extent possible. The ARO, a subsystem of the present embodiment of PACA Space Debris Environmental Gaming Protocol, will accelerate the completion of such a catalog by providing the necessary data.

One of the novelties of the ARO is to combine a cost-effective optical sensor for Low Earth Orbit debris detection comprising a tracking telescope (thereby creating a tracking optical sensor), whereas prior art had developed a cost-effective optical sensor comprising a fixed-pointing telescope [Shell]. As shown in the attached drawings (entitled “fixed pointing optical performance analysis” and “tracking optical sensor performance analysis”), a computer simulation using AGI's Satellite Toolkit, an industry-standard software package in astrodynamics, shows that a tracking optical sensor when compared with a fixed-pointing optical sensor achieves 333% more geometric access time over a 24 hour period. Geometric access time denotes a time window during which a line of sight may be established between the optical sensor and target debris objects and was measured using a population of debris fragments from the Iridium-33/Cosmos 2251 collision. This collision was a good example for a debris cloud producing collision which may occur in the future, although the ARO system is not limited to debris clouds which are byproducts of major collisions. The specific access time values are 2872.867 seconds for the tracking optical sensor versus 862.061 seconds for the fixed-pointing optical sensor. Both telescopes had 5 degree fields of view and were located directly below the debris cloud's orbit on the Earth's surface (at a point corresponding to Emas, Brazil). The fixed-pointing optical sensor was oriented at an elevation angle of 30 degrees and given an azimuth angle of 20 degrees so that it was aligned with the position of the densest region of the debris cloud on the first orbital pass. The tracking optical sensor was allowed to swivel and tilt through all possible values of azimuth and elevation. Clearly the performance of the tracking optical sensor, the model for the ARO system, was far superior to that of the fixed-pointing optical sensor.

In this embodiment, the ARO is at least partially powered by solar energy, and can store electricity in an internal battery. The ARO can provide electricity to nearby mobile devices using an electrical, magnetic, or electromagnetic transmission means. The ARO has a rugged exterior structure and dome containing one or more optical telescopes and one or more detectors. The optical telescopes are attached to a pivoted support that allows rotation about at least one axis, enabling the telescopes to follow the motion of an RSO across the sky. At least one of the telescopes will be a reflecting telescope with an aperture larger than 10 cm in diameter and providing a field of view of no less than 3 degrees. One of the telescopes may be a refracting telescope with an aperture larger than 10 cm and providing a field of view of no less than 3 degrees. The field of view requirement drives the design towards the parameter space of fast optical systems. At least one of the detectors will have a pixel size of no less than 20 microns. The pixel size is large compared to the point spread function of the telescope/optical system. At least one of the detectors will have or will be controlled by software which has an integration time designed for high angular rate motion (at least 100 arcsec per second). The ARO contains a satellite communications device for uplink and downlink to satellites in Earth orbit (called an “upstream” communications device). The ARO also contains a computer system, data storage devices, and control electronics. The ARO may also contain a set of routers and radio frequency (RF) communications devices including cellular, mesh and/or WiFi communications which will enable nearby client devices to send and receive data to each other and to said computer system. The ARO may have a rotating dome which may be sealed using a motorized door. ARO is placed in sites which have good “seeing” as defined by low light pollution and favorable atmospheric conditions.

Operating the ARO at lower elevation angles dramatically increases the LEO orbit intersection volume—approximately 90% of debris object passes occur at elevation angles less than 50 degrees. For a tracking optical sensor integration time may typically correspond to angular velocities that may approach 5000 arcsec per second for low orbiting objects observed at high elevation angles. Of particular interest is that aperture sizes less than 20 cm have detection capabilities for objects 10 cm and smaller or below the nominal size of cataloged objects. Also the resulting integration times are very short compared to typical standards: 20 milliseconds for a 20 cm aperture optimized for a 1000 arcsec/sec object. The short integration times result in read noise dominating over the background noise as seen in comparing actual and theoretical performance results (where actual performance includes the effect of read noise). Mated with a large format CCD, the 20 cm telescope of this design provides a 10 degree FOV with a 20 arcsec IFOV.

The detection process in the ARO is practically accomplished by applying a threshold to individual digital counts for each pixel while accounting for known objects such as stars. Detector read noise will limit the performance under circumstances when objects have a high angular rate and/or low background radiance.

Given the sensor performance in simulations, a significant innovation is thus presented which stands to contribute substantively to LEO debris surveillance. Multiple apertures enable very large fields of view providing high volume and cost effective coverage. Proper latitude placement extends the required terminator lighting conditions while multiple sites mitigate weather impacts. The metric position accuracies in detecting and tracking debris are projected to exceed that of most radar systems.

Orbital debris detection alone is primarily useful for the statistical characterization of the debris population. In the end, maintaining debris objects in a catalog is sought-after capability, where updates of sufficient frequency occur so that mission impacts from potential collisions may be mitigated. Furthermore, positional accuracy improvements enabled by more frequent monitoring minimize the error associated with conjunction events, thus reducing collision avoidance maneuvers required by satellite operators. This is particularly true for the congested LEO orbit, where uncertain atmospheric drag effects impact the orbit propagation fidelity. Beyond detection, three quantities are required to develop and refine orbital parameters of debris objects: the sensor position, the time of the measurement, and the position of the debris object being observed, where position is the angles-only position as referenced by the stellar background. By mapping the known stellar background positions to the focal plane, accurate absolute positions may be determined at the sub-pixel level. The position accuracy is interdependent with the detection performance of optical systems emphasized in this work, as it directly correlates to the field of view of a single pixel, or IFOV (instantaneous field of view) of the system. For the wide field, ground-based systems monitoring LEO, further work is required to better understand how they may be used to provide an initial orbit solution such that subsequent correlations required to generate quality orbital parameters are obtained. At a minimum, these systems should be able to provide updates to the orbits of existing objects. Although a metric accuracy of 10 asec is usually considered poor under the typical circumstances of observing GEO objects, this translates into distances of ˜27 m to 83 m for LEO orbits when viewed at a 30 degree elevation angle and spanning orbit altitudes from 300 km to 1000 km, a significant improvement upon current state of the art for small debris orbital position measurements.

Commercial advances in optical system design, detector technology, and computational capabilities have allowed for an opportunity to develop a system which achieves significant performance from telescopes to monitor orbital debris. The new approach of broad area LEO surveillance from small aperture ground-based systems holds significant promise when combined with tracking capability to increase the duration of geometric access with respect to a cloud of orbital debris.

The user may operate the PACA ARO remotely by sending commands over the satellite link to the PACA ARO computer. The user may operate the PACA ARO on site by providing commands to the internal computer via the RF communications network or other interface. Commands might be one of the following things: begin data transmission, end data transmission, begin observation, end observation, receive new observation schedule, enable automatic mode, disable automatic mode, enter power saving mode, exit power saving mode, enable local RF communications, disable local RF communications, purge data, recover data, enable satellite communications, disable satellite communications, update software, restore previous software.

### The Laser Debris Removal Stations (LDRS):

It is known in the art that powerful electromagnetic beams can be produced by high energy solid-state lasers (lasers with peak power outputs greater than 100 Watts which may be based on Yb, GGG, and Nd solid-state materials operating near 1 micron wavelength). One promising approach is based on the Nd:YAG solid state heat capacity (or alternatively diode pumped solid state) lasers. A power output of kilowatts from a solid-state heat capacity laser has been achieved [Yamamoto 2007]. Such lasers require a beam generator, which may comprise pumping mechanisms such as diode or flashlamp pumps, a laser gain medium, and mechanisms for correction and stabilization of the output beam. Such mechanisms for beam correction and stabilization may include mirrors and deformable mirrors, lenses, filters, beam splitters, adaptive optics and beam steering optics including tip-tilt mirrors and fast steering mirrors. For example, adaptive optics can correct for wavefront errors induced by thermal gradients in the laser gain media or by beam interaction with an external medium like the atmosphere (see the drawing entitled “laser guide star and adaptive optics means example”). Some of these laser systems have been developed to be compatible with mobile field operation. The use of lithium-ion batteries which provide a rechargeable power source for the laser system is a prime example of where a laboratory device had integrated this capability early on in its development [Yamamoto 2007]. According to the prior art, the laser power can be linearly increased at least two ways: (a) increasing the number of laser gain media and (b) increasing the cross sectional area of the laser gain media.

The present embodiment of the LDRS is a mobile system which may be positioned in proximity to an ARO. The LDRS comprises an enclosure housing beam directors, high powered solid state lasers, and other technologies such as adaptive optics and laser guide star systems. As embodiment of the laser subsystem in the LDRS is shown in the drawing entitled “laser beam generator”. Further embodiments of LDRS components are shown in the drawings entitled “beam correction system components”, “beam director”, and “beam pointing system”. Calculations denoting potential capabilities of the LDRS when used to de-orbit space debris are shown in the drawing entitled “perturb the orbits of resident space objects” whereby it is shown that the LDRS can de-orbit a cloud of 1-10 cm debris initially at 800 km altitude in less than 3 months. This performance is significant, especially in the scenario of a fresh cloud of debris resulting from a collision For example, the cloud of debris from the 2009 collision between satellites Iridium-33 and Cosmos-2251 could have been surgically removed with an LDRS system, thereby preventing the dramatic doubling in debris population which occurred as a result of 2009 and 2007 collisions. Note that the LDRS may be used to target individual debris objects or clouds of debris objects.

Additional information regarding embodiments of LDRS components are found in the drawings entitled “tracking lock”, “adaptive optics means”, “laser guide star and adaptive optics means example”, “beam control system”, and “second laser beam generator”.

### PACA Virtual Astrometry Protocol (VAP):

The VAP comprises an observation node, an upstream communications channel, a plurality of RF-enabled mobile devices with imaging systems (denoted “cameras”), and specialized software. The observation node may comprise the ARO previously described and the upstream communications channel is that an embodiment of which is shown in the drawing entitled “communications channel.” The RF-enabled mobile devices may comprise an iPhone or equivalent which uses wireless mesh, wi-fi, or cellular communications technology for establishing a data link between the mobile device, other mobile devices, and/or the observation node. Specialized software may comprise a multi-media capable browser interface which allows access between the mobile device and other websites on the internet. In addition the software may include specific applications which function outside the browser providing education and entertainment, as well as utilization of the mobile device's camera and/or RF networking capability.

The present embodiment of the VAP operates in the following manner. The user interacts with the mobile device by touching the screen, pressing buttons, creating sound near the device, or varying the device's orientation or location. The device displays images, plays sounds, takes pictures, records sounds, and vibrates for the user. Software on the mobile devices form communications gateways between users and the observation node. The observation node in turn serves as a relay device for bi-directional communication to and from mentors and the internet.

Furthermore additional specialized software may apply synthetic or sparse aperture array techniques to combine data from the RF-enabled mobile devices with data from the observation node so as to synthesize data from a virtual aperture that registers more information than the aperture observation node alone. See the drawing entitled “synthetic aperture” and the glossary for more information on synthetic aperture technology.

### Central Station:

One embodiment of the central station comprises a plurality of computers, displays, and communications means which engage in the reduction and analysis of data from and control of a plurality of AROs, LDRSs and associated software systems. Such a facility may or may not involve human engineers and scientists. One output of this embodiment of a central station is orbital position data for resident space objects in the size range of 1-10 cm. See the drawing entitled “central station” for an example of what a central station might look like. See the drawing entitled “computer system” for an example of what a computer in a central station might look like.

### Additional Embodiments

In one embodiment, a network could be established of ARO systems all operating within a given radius so as to communicate with each other, with the Control Station, and with nearby mobile devices.

In another embodiment the ARO system could have multiple domes, computers, satellite communications means, local RF communications means, batteries, control electronics, or solar panels.

In yet another embodiment, one or more ARO systems could be combined with one or more LDRS systems so as to form a system capable of tracking and modifying the orbits of one or more RSOs.

In yet another embodiment, an ARO could be outfitted with an adaptive optics system to overcome atmospheric wavefront distortion of the incoming light from the RSO. Such an embodiment could include a laser guide star means, as described in the glossary.

In yet another embodiment, one or more ARO systems could be outfitted with both a wide field of view sensor (FOV>3 degrees) and a narrow field of view sensor (FOV<3 degrees) as well as being combined with one or more LDRS. This approach enables the embodiment to lock a laser beam onto the targeted resident space objects with pointing accuracy superior over prior art.

In yet another embodiment, the game software could operate on a plurality of mobile devices, computers, internet browser, and console gaming systems.

In yet another embodiment, the game software could interface with social media websites allowing the user to play with one or more users over the internet.

In yet another embodiment, the game software could comprise a dedicated operating system or specialized operating environment running on the mobile devices or computers.

In yet another embodiment, the game software could involve massively multiplayer online gaming exercises where villagers play with other villagers or with other players on the internet.

### CONCLUSIONS, RAMIFICATIONS, AND SCOPE

Therefore the described embodiment of the PACA Space Debris Environmental Gaming Protocol enables the detection, tracking, cataloging, and removal of space debris in Low Earth Orbit. In doing so, the embodiment makes use of codes generated by players of an augmented reality game where players attempt to complete a number of challenging space debris cleanup scenarios. By allowing a multitude of people to contribute to a positive environmental and humanitarian cause in an entertaining manner, this embodiment aims to better the both environment and multi-player gaming communities (e.g. the massively multiplayer online gaming community) by enhancing education and awareness of global human values. For this reason, this embodiment attempts to create a network of mentors who can provide, through the game interface, guidance to youngsters whether they are from modernized western countries or from other less technologically advanced nations. Such an educational support network may even comprise villagers in a remote location where a PACA ARO system is located, and where the ARO enables access to a game and to mentors who might greatly influence the lives of the children they touch. This increased unity of human beings behind a worthwhile environmental cause is an object of the present embodiment of PACA Space Debris Environmental Gaming Protocol.

While the Earth orbit is discussed above, it is contemplated that the orbits about other bodies (e.g. planets, moon, stars, etc.) could similarly be performed.

These disclosed systems and methods may overcome various limitations in the art, including among others, specifying a new technology for detection, tracking, cataloging and/or removal of objects from space which demonstrates superior performance over prior art, providing a laser debris removal means with advanced performance in removing space debris in the aftermath of a collision in low Earth orbit, establishing connectivity between villagers and mentors via a multi-player game environment where scientific education is the byproduct of the communication, improving technology involved in augmented reality games through enabling players to actively resolve one of the greatest environmental and economic hazards of the current age, and setting forth a model for a multi-user community (potentially including social media interfaces) comprising elements of augmented reality technology.

Other embodiments, uses and advantages of the inventive concept will be apparent to those skilled in the art from consideration of the above disclosure and the following claims. The specification should be considered non-limiting and exemplary only, and the scope of the inventive concept is accordingly intended to be limited only by the scope of the following claims.

We claim:

1. An optical sensor machine for observing, recording, processing and relaying data, some portion of which represents the motion of resident space objects, said machine comprising:
(a) an optical telescope of predetermined aperture diameter
(b) a motorized pivoted support that allows the rotation of said telescope about one or more axes
(c) a plurality of focal plane arrays which convert light from said telescope into electrical signals and which, when coupled with 2(a), provide fields of view of predetermined angular dimensions
(d) a computer system which records and processes said electrical signals and which generates a control signal for said motorized pivotal support
(e) software tied to said computer system which enables said telescope to follow the movement of one or more resident space objects
(f) first radio frequency communications device which transmits and receives data between said computer system and a control station (
(g) second radio frequency communications device which transmits and receives data between said computer system and a plurality of mobile devices
whereby said optical sensor machine comprises a telescope of predetermined aperture diameter and fields of view which is also a tracking optical sensor and where the tracking functionality significantly enhances the performance of said optical sensor machine in detecting resident space objects; said optical sensor machine is further combined with the means to exchange data with local villagers wherever the machine is situated

2. A method for providing a communications channel between players of an educational game using the internet and local networks, wherein said players benefit from entertainment, a positive information exchange, and mentorship opportunities, said method comprising:
(a) using a plurality of mobile devices to display images, play audio, play video, and produce vibrations
(b) conveying the space debris theme
(c) using a plurality of mobile devices to record data embodying images, video, screen taps, button presses, and audio as well as positions and motions of said mobile devices
(d) enabling players to complete levels once said player catalogs or eliminates a sufficient amount of resident space objects, or when said player forms a pairing with a mentor or mentee and exchanges beneficial information; said levels substantiate the gradual introduction of details and realism into the game
(e) processing said data both locally (on the processor of one or more recording mobile devices) and in a distributed fashion (on other processors outside said mobile devices) so as to correlate, organize and reduce information
(f) teaching players how to think scientifically
(g) transmitting said data via radio frequency communications to other mobile devices and to a central router means
(h) utilizing an interface which allows the user to generate codes
(i) enabling said players to communicate a solution of one aspect of the space debris problem to remote computers and players
(j) employing an algorithm tied to a mobile device and other computing devices in the mobile device's upstream network which identifies creative potential expressed in said codes issued by said user during gameplay
(k) utilizing communications sockets on said mobile devices for transmitting and receiving data over local networks and the internet where said data may comprise mentor/mentee communication, gaming information, said codes, or updates which may ultimately be stored, processed, or communicated to social media websites
whereby through enabling players to directly participate in the global effort to solve the space debris problem, said method creates the potential for a social/economic infrastructure based on the exchange of information to emerge uniting players who are villagers with players from modern nations in a harmonious manner, and advancing the knowledge and understanding of our universe

3. A laser debris removal machine which functions to irradiate space debris objects between 1 and 10 cm in size, comprising:
(a) a plurality of laser beam generators generating beams of sufficient power so as to perturb the orbits of resident space objects in a predetermined manner
(b) a beam steering system comprising a beam director, optical elements, beam correction systems, and beam pointing systems
(c) a laser beam generator for illuminating resident space objects in a controlled manner so as to increase the accuracy to a predetermined level of said beam steering system
(d) a computer system comprising software which establishes and maintains a tracking lock on the targeted resident space objects throughout a predetermined portion of their overhead passes
whereby through clearing resident space objects which are space debris, said machine will potentially enable humanity to venture into space with a lesser degree of life-threatening danger and will consequently create more opportunities for space exploration

4. Claim 1 together with the additional subject matter of claim 2

5. Claim 1 together with the additional subject matter of claim 3

6. Claim 4 together with the additional subject matter in claim 3.

7. Claim 3 together with an adaptive optics means, comprising:
(a) a plurality of deformable mirrors, a plurality wavefront sensors, and a plurality of computer systems which form an adaptive optics control system which functions to detect and correct for wavefront distortion of said laser beam due to atmospheric effects

8. claim 7 together with a laser guide star means, comprising:
(a) a plurality of secondary laser beam generators and a plurality of secondary beam control systems which function together to illuminate a portion of the upper atmosphere so as to create an artificial guide star for the purpose of enhancing the functionality of said adaptive optics means

9. Claim 3 together with a software means for calculating the effect of said beams on the orbit of said resident space objects where said software means for calculating comprises a model of the effect of photon pressure and said software means is tied to a computer processor in a control station

10. Claim 3 together with a software means for calculating the effect of said beams on the orbit of said resident space objects where said software means for calculating comprises a model of the Poynting-Robertson effect and said software means is tied to a computer processor in a control station

11. Claim 3 together with a software means for calculating the effect of said beams on the orbit of said resident space objects where said software means for calculating comprises a model of the effect of ablation and said software means is tied to a computer processor in a control station

12. Claim 4 together with a control station means, comprising:
(a) a computer system providing an information gateway between the machine described in claim 1 and space debris gaming software elements which are tied in part to said mobile devices of claim 2, and in part to computer systems which are upstream from said mobile devices

13. Claim 4 together with a control station means, comprising:
(a) a computer system providing an information gateway between space debris gaming software elements which are tied in part to said mobile devices of claim 2 and in part to computer systems which are upstream from said mobile devices; said information gateway is established utilizing the method of claim 2 together with the machine of claim 1

14. Claim 4 together with claim 3 together with a control station means, comprising:
(a) a computer system providing an information gateway between the machine described in claim 1 and the machine described in claim 3

15. Claim 12 wherein said gateway comprises a bi-directional information filter comprising machine learning algorithms tied to a computer processor in said control station

16. Claim 13 wherein said gateway comprises a bi-directional information filter comprising machine learning algorithms tied to a computer processor in said control station

17. Claim 1 together with a software means which comprises synthetic aperture technology to enhance the data provided by a plurality of machines as described in claim 1 and where said software means is tied to a computer processor in a control station

18. Claim 1 together with claim 2, together with a software means which comprises synthetic aperture technology to enhance the data provided by the machine of claim 1 and the mobile devices of claim 2 and where said software means is tied to a computer processor in a control station

19. Claim 3, wherein
(a) one laser beam generator produces a laser beam of sufficient peak power to produce the effect of ablation on targeted space debris
(b) one laser beam generator produces a beam of sufficient average power to perturb the orbits of targeted space debris using photon pressure
whereby a machine is formed that can simultaneously combine a plurality of laser beam means for rapid and versatile removal of 1-10 cm debris from low earth orbit

20. Claim 4 together with claim 19
